(19) United States
(12) Patent Application Publication
(10) Pub. No.: US 2020/0360957 A1
(43) Pub. Date: Nov. 19, 2020

(54) ATOMIZING DEVICE AND HUMIDITY REGULATING DEVICE

(71) Applicant: SHARP KABUSHIKI KAISHA, Sakai City, Osaka (JP)

(72) Inventors: JUN SAKUMA, Sakai City, Osaka (JP); SHO OCHI, Sakai City, Osaka (JP); TETSUYA IDE, Sakai City, Osaka (JP)

(21) Appl. No.: 16/966,773

(22) PCT Filed: Feb. 27, 2019
(86) PCT No.: PCT/JP2019/007556

§ 371 Date: Jul. 31, 2020

(30) Foreign Application Priority Data
Feb. 27, 2018 (JP) 2018-033239

(51) Int. Cl. B05B 17/06; F24F 6/12; F24F 3/14

(52) U.S. Cl. CPC B05B 17/06; F24F 3/1417; F24F 6/12

(57) ABSTRACT

Provided is an atomizing device capable of obtaining high atomization efficiency while suppressing deterioration in reliability of an ultrasonic wave generation unit regardless of a type of a liquid to be atomized. An atomizing device according to one aspect of the present invention includes: a housing that has an internal space for storing a first liquid material to be mist-like droplets and an air discharge port; an ultrasonic wave generation unit that is provided in the housing and generates the mist-like droplets by irradiating the first liquid material with ultrasonic waves; an airflow generation unit that generates an airflow for sending at least a part of the mist-like droplets from the internal space to the outside through the air discharge port; and an ultrasonic wave propagation member that is provided on a propagation path of the ultrasonic waves between the ultrasonic wave generation unit and the first liquid material in the internal space, and has an attenuation coefficient smaller than an attenuation coefficient of the first liquid material.

### TECHNICAL FIELD

The present invention relates to an atomizing device and a humidity regulating device.

Priority is claimed on Japanese Patent Application No. 2018-033239 filed Feb. 27, 2018, the content of which is incorporated herein by reference.

### BACKGROUND ART

An ultrasonic atomizing device that irradiates a liquid with ultrasonic waves to generate mist has been known in various technical fields such as a humidifier, a nebulizer, and a separation device. For example, PTL 1 below discloses an ultrasonic nebulizer that includes a working tank equipped with an ultrasonic transducer and storing a working liquid and a chemicals tank immersed in the working liquid and storing a chemical liquid. In the ultrasonic nebulizer, the chemicals tank can be attached and detached to and from the working tank. In the present invention, PTL 1 states that the chemicals tank can be easily removed from the working tank, and therefore, the working tank can be easily cleaned and sterilized.

### CITATION LIST

### Patent Literature

PTL 1: Japanese Unexamined Patent Application Publication No. 2016-182192

### SUMMARY OF INVENTION

### Technical Problem

This type of the atomizing device needs to atomize a high-viscosity liquid depending on its use. However, in a case where a high-viscosity liquid is irradiated with ultrasonic waves, an attenuation of ultrasonic wave when propagating through the liquid is larger than that in a case where a low-viscosity liquid is irradiated with ultrasonic waves. Therefore, there is a problem that more ultrasonic waves are attenuated until the ultrasonic waves reach a liquid level from a bottom of a tank, and atomization efficiency is thus lowered. In the present specification, the atomization efficiency is defined as “atomization efficiency=atomization amount/energy required for atomization”.

As means for reducing the attenuation of ultrasonic waves, it is considered to reduce an amount of liquid stored in the tank to shorten a distance from a bottom surface of the tank to the liquid level. However, in this case, if no liquid is present above an ultrasonic transducer due to, for example, inclination or oscillation of the tank, the ultrasonic transducer may be damaged by being operated without liquid. Alternatively, even if liquid is present above the ultrasonic transducer, the ultrasonic wave reflected by the liquid level returns with high intensity because the amount of liquid is small, and the ultrasonic transducer may be damaged.

In order to solve the above problems, an object of one aspect of the present invention is to provide an atomizing device capable of obtaining a high atomization efficiency while suppressing deterioration in reliability of an ultrasonic wave generation unit regardless of a viscosity of a liquid to be atomized. Another object of one aspect of the present invention is to provide a humidity regulating device including the atomizing device described above.

### Solution to Problem

In order to achieve the object, an atomizing device according to one aspect of the present invention includes: a housing that has an internal space for storing a first liquid material to be mist-like droplets and an air discharge port; an ultrasonic wave generation unit that is provided in the housing and generates the mist-like droplets by irradiating the first liquid material with ultrasonic waves; an airflow generation unit that generates an airflow for sending at least a part of the mist-like droplets from the internal space to the outside through the air discharge port; and an ultrasonic wave propagation member that is provided on a propagation path of the ultrasonic waves between the ultrasonic wave generation unit and the first liquid material in the internal space, and has an attenuation coefficient smaller than an attenuation coefficient of the first liquid material.

In the atomizing device according to one aspect of the present invention, the ultrasonic wave propagation member may have a partition member that partitions the internal space, and at least a part of the partition member may be made of a material having an attenuation coefficient smaller than the attenuation coefficient of the first liquid material.

In the atomizing device according to one aspect of the present invention, the ultrasonic wave propagation member may contain a second liquid material having a viscosity lower than a viscosity of the first liquid material, the second liquid material may be stored in a space close to the ultrasonic wave generation unit among a plurality of spaces partitioned off by the partition member, and the first liquid material may be stored in a space far from the ultrasonic wave generation unit among the plurality of spaces.

In the atomizing device according to one aspect of the present invention, the housing may include a first container and a second container that is attachable to and detachable from an internal space of the first container, at least a part of the second container may function as the partition member in a state where the second container is mounted in the internal space of the first container, the second liquid material may be stored in a space between the first container and the second container, and the first liquid material may be stored in an internal space of the second container.

In the atomizing device according to one aspect of the present invention, the ultrasonic wave generation unit may include a plurality of ultrasonic transducers, and the partition member may be provided to partition off an upper space of each of the plurality of ultrasonic transducers.

In the atomizing device according to one aspect of the present invention, the partition member may have a thickness larger than a thickness of a layer of the second liquid material.

In the atomizing device according to one aspect of the present invention, the partition member may include an acoustic lens unit that converges the ultrasonic waves toward a specific region of the first liquid material.

In the atomizing device according to one aspect of the present invention, the partition member may include a cylindrical portion that converges the ultrasonic waves toward a specific region of the first liquid material.

In the atomizing device according to one aspect of the present invention, the cylindrical portion may have an inflow port that allows the first liquid material to flow into the cylindrical portion.

A humidity regulating device according to one aspect of the present invention includes: a moisture absorption unit that causes a liquid-moisture absorbing material to absorb at least a part of moisture contained in air by bringing the liquid-moisture absorbing material containing a hygroscopic substance into contact with the air; and an atomization regeneration unit that regenerates the liquid-moisture absorbing material by atomizing and removing at least a part of moisture contained in the liquid-moisture absorbing material supplied from the moisture absorption unit, in which the atomization regeneration unit includes the atomizing device according to one aspect of the present invention.

### Advantageous Effects of Invention

According to the atomizing device according to one aspect of the present invention, high atomization efficiency can be ensured regardless of the type of liquid to be atomized, without deteriorating reliability of the ultrasonic wave generation unit. Moreover, according to one aspect of the present invention, it is possible to provide a humidity regulating device including the atomizing device described above.

### BRIEF DESCRIPTION OF DRAWINGS

FIG. 1 is a cross-sectional view illustrating an atomizing device according to a first embodiment.

FIG. 2 is a cross-sectional view illustrating an atomizing device according to a second embodiment.

FIG. 3 is a cross-sectional view illustrating an atomizing device according to a third embodiment.

FIG. 4 is a cross-sectional view illustrating an atomizing device according to a fourth embodiment.

FIG. 5 is a cross-sectional view illustrating an atomizing device according to a fifth embodiment.

FIG. 6 is a cross-sectional view illustrating an atomizing device according to a sixth embodiment.

FIG. 7 a cross-sectional view illustrating an atomizing device according to a seventh embodiment.

FIG. 8 is a cross-sectional view illustrating an atomizing device according to an eighth embodiment.

FIG. 9 is a perspective view of a nozzle in the atomizing device according to the eighth embodiment.

FIG. 10 is a schematic configuration diagram illustrating a humidity regulating device according to a ninth embodiment.

### DESCRIPTION OF EMBODIMENTS

### First Embodiment

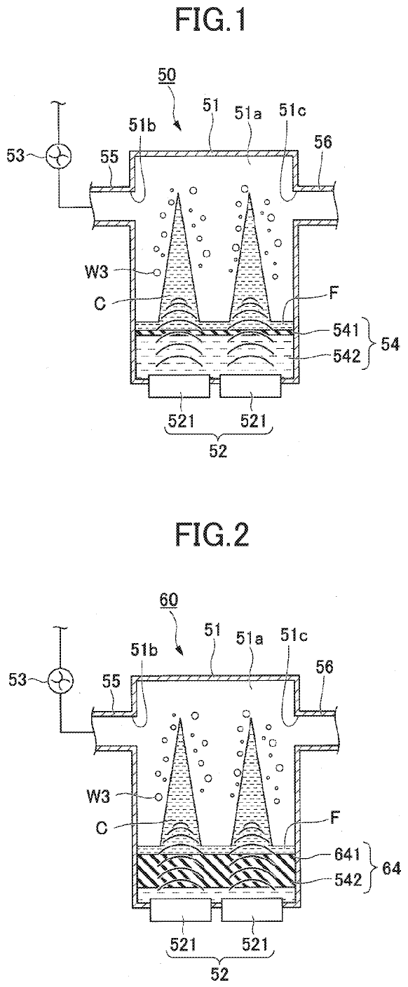

Hereinafter, a first embodiment of the present invention will be described with reference to FIG. 1.

FIG. 1 is a cross-sectional view illustrating an atomizing device according to the first embodiment.

Note that, some components may be shown with a different scale of a size so that each component is easily viewed in each of the following drawings.

As illustrated in FIG. 1, an atomizing device 50 includes a housing 51, an ultrasonic wave generation unit 52, an airflow generation unit 53, and an ultrasonic wave propagation member 54.

The housing 51 has an internal space 51a for storing a first liquid material F as mist-like droplets W3, an air supply port 51b, and an air discharge port 51c. The housing 51 is a container made of a material such as metal or resin, and a constituent material thereof is not particularly limited. An air supply pipe 55 is connected to the air supply port 51b, and an air discharge pipe 56 is connected to the air discharge port 51c.

The first liquid material F has a viscosity of, for example, 3×10⁻³ Pa·s or more. As described above, the first liquid material F is constituted by a liquid having a relatively high viscosity. Specific examples of the first liquid material F include glycerin, ethylene glycol, a sodium polyacrylate aqueous solution, polyethylene glycol, triethylene glycol, a calcium chloride aqueous solution, a lithium chloride aqueous solution, or a mixed solution thereof.

Acoustic characteristics (attenuation coefficient, acoustic impedance, viscosity, and sound velocity) of the materials described above are summarized in [Table 1] below. Each characteristic value is a value when an ultrasonic frequency is 1 MHz and a liquid temperature is 20° C.

TABLE 1

| | Attenuation | Acoustic | | Sound |
|---|---|---|---|---|
| | coefficient | impedance | Viscosity | velocity |
| | [dB/m] | [kg/m² · s] | [Pa · s] | [m/s] |
| Glycerin | 6.78 × 10⁴ | 2.40 × 10⁶ | 1.40 | 1930 |
| Ethylene glycol | 1.16 × 10³ | 1.85 × 10⁶ | 2.00 × 10⁻² | 1666 |
| 10 wt % of Sodium | 9.75 × 10⁴ | 1.76 × 10⁶ | 1.00 | 1600 |
| polyacrylate | | | | |
| aqueous solution | | | | |
| Polyethylene glycol | 3.50 × 10³ | 1.92 × 10⁶ | 6.50 × 10⁻² | 1700 |
| Triethylene glycol | 2.60 × 10³ | 1.91 × 10⁶ | 4.80 × 10⁻² | 1700 |
| 30 wt % of Calcium | 6.05 × 10¹ | 2.56 × 10⁶ | 3.90 × 10⁻³ | 2000 |
| chloride aqueous | | | | |
| solution | | | | |
| 30 wt % of Lithium | 5.89 × 10¹ | 2.56 × 10⁶ | 3.80 × 10⁻³ | 2000 |
| chloride aqueous | | | | |
| solution | | | | |

When the viscosity of the material is defined as η, the bulk viscosity is defined as μ, the density is defined as ρ, the sound velocity is defined as c, and the ultrasonic frequency is ω, an attenuation coefficient α that is defined as the ease of attenuating ultrasonic wave in the material is defined by the following Equation (1).

α=(2η/3+μ/2)ω²/ρc³ (1)

In addition, when the amplitude of the ultrasonic wave generated by the ultrasonic transducer is defined as A₀, a propagation distance of the ultrasonic wave is defined as x, and the amplitude when the ultrasonic wave propagates by a distance x is defined as A, the attenuation coefficient α is expressed by the following Equation (2).

A=A₀×exp(−α/x) (2)

That is, the attenuation coefficient represents several powers of ten of an amplitude of the propagating ultrasonic wave while propagating by unit length.

A pulse method, a correlation method, a reverberation method, and the like are known as methods of measuring an attenuation coefficient, and, for example, an ultrasonic attenuation and sound velocity measuring device is used as a measuring device.

The ultrasonic wave generation unit 52 is provided in the housing 51, and irradiates the first liquid material F with ultrasonic waves to generate mist-like droplets W3 from the first liquid material F. In the present embodiment, the ultrasonic wave generation unit 52 includes a plurality of ultrasonic transducers 521 provided at a bottom plate of the housing 51. The number of the plurality of ultrasonic transducers 521 is not particularly limited. However, the ultrasonic wave generation unit 52 may not necessarily include the plurality of ultrasonic transducers 521 and may include one ultrasonic transducer 521. When the ultrasonic waves are irradiated from the ultrasonic transducer 521 to the first liquid material F, the ultrasonic waves are focused into a specific portion of the liquid level of the first liquid material F by adjusting a generation condition of the ultrasonic waves, and a liquid column C of the first liquid material F can thus be generated. The mist-like droplets W3 are generated from any portion of the liquid level, but are particularly generated from the liquid column C and the vicinity thereof.

The airflow generation unit 53 generates an airflow for sending at least a part of the mist-like droplets W3 from the internal space 51a to the outside through the air discharge port 51c of the housing 51. In the present embodiment, the airflow generation unit 53 is constituted by a blower provided in the air supply pipe 55. The airflow generation unit 53 is not limited to the air supply pipe 55, and may be constituted by a blower provided in the air discharge pipe 56.

The ultrasonic wave propagation member 54 is provided on a propagation path of the ultrasonic wave between the ultrasonic wave generation unit 52 and the first liquid material F in the internal space 51a of the housing 51. The ultrasonic wave propagation member 54 has an attenuation coefficient smaller than that of the first liquid material F. Since the ultrasonic wave propagation member 54 is provided, the ultrasonic waves generated by the ultrasonic wave generation unit 52 are propagated to the liquid level of the first liquid material F with a high strength through the ultrasonic wave propagation member 54, as compared with a case where the ultrasonic wave propagation member 54 is not provided.

The ultrasonic wave propagation member 54 includes a partition member 541 that partitions the internal space 51a of the housing 51, and a second liquid material 542 having a viscosity lower than that of the first liquid material F. The second liquid material 542 is stored in a space close to the ultrasonic wave generation unit 52 (space below the partition member 541) among a plurality of spaces partitioned off by the partition member 541, and the first liquid material F is stored in a space far from the ultrasonic wave generation unit 52 (space above the partition member 541). Therefore, the first liquid material F and the second liquid material 542 do not mix together in the internal space 51a of the housing 51.

The partition member 541 is constituted by a plate-shaped member that is horizontally arranged inside the housing 51, and partitions the internal space 51a into two spaces. The partition member 541 is made of a material having an attenuation coefficient smaller than that of the first liquid material F. Specific examples of the constituent materials of the partition member 541 include rubber, polyethylene, polystyrene, and the like. It is preferable that the whole partition member 541 is made of the materials described above, but at least a part (for example, immediately above the ultrasonic transducer 521) of the partition member 541 may be made of the materials described above.

Acoustic characteristics (attenuation coefficient, acoustic impedance, and sound velocity) of the materials described above are summarized in [Table 2] below. Each characteristic value is a value when an ultrasonic frequency is 1 MHz and a temperature is 20° C.

TABLE 2

| | Attenuation | Acoustic | Sound |
|---|---|---|---|
| | coefficient | impedance | velocity |
| | [dB/m] | [kg/m² · s] | [m/s] |
| Rubber | 4.75 × 10² | 1.50 × 10⁶ | 1500 |
| Polyethylene | 5.00 × 10² | 1.80 × 10⁶ | 2200 |
| Polystyrene | 1.00 × 10² | 2.50 × 10⁶ | 2390 |

The second liquid material 542 has a viscosity of, for example, less than 3×10⁻³ Pa·s. As described above, the second liquid material 542 has a viscosity lower than that of the first liquid material F and is made of a liquid having an attenuation coefficient smaller than that of the first liquid material F. Specific examples of the second liquid material 542 include water, ethanol, acetone, or a mixed solution thereof.

Acoustic characteristics (attenuation coefficient, acoustic impedance, viscosity, and sound velocity) of the materials described above are summarized in [Table 3] below. Each characteristic value is a value when an ultrasonic frequency is 1 MHz and a liquid temperature is 20° C.

TABLE 3

| | Attenuation | Acoustic | | Sound |
|---|---|---|---|---|
| | coefficient | impedance | Viscosity | velocity |
| | [dB/m] | [kg/m² · s] | [Pa · s] | [m/s] |
| Water | 5.00 × 10¹ | 1.50 × 10⁶ | 1.00 × 10⁻³ | 1470 |
| Ethylene | 1.51 × 10² | 9.23 × 10⁵ | 1.20 × 10⁻³ | 1168 |
| Acetone | 3.82 × 10¹ | 9.40 × 10⁵ | 3.20 × 10⁻⁴ | 1190 |

As in the present embodiment, when the ultrasonic wave propagation member 54 is constituted by a partition member 541 and the second liquid material 542, it is preferable to satisfy the following Equation (3), where the acoustic impedance of the first liquid material F is defined as Z₁, the acoustic impedance of the second liquid material 542 is defined as Z₂, and the acoustic impedance of the partition member 541 is defined as Zₛ.

Z_{S}=√(Z₁·Z₂) (3)

That is, it is preferable that a material of which the acoustic impedance Z_{S} is close to a geometric mean of the acoustic impedance Z₁ of the first liquid material F and the acoustic impedance Z₂ of the second liquid material 542 is selected as a material of the partition member 541, and it is more preferable that a material of which the acoustic impedance Z_{S} is equal to the geometric mean of the acoustic impedance Z₁ and the acoustic impedance Z₂ as a material of the partition member 541. In this case, it is possible to minimize reflection on ultrasonic waves at an interface between the second liquid material 542 and the partition member 541 and an interface between the partition member 541 and the first liquid material F.

As described above, if the reflection on ultrasonic waves at the interface between the second liquid material 542 and the partition member 541 and the interface between the partition member 541 and the first liquid material F is sufficiently reduced, and influence on the reflection can thus be ignored, an attenuation coefficient αₜₒₜₐₗ of the whole ultrasonic wave propagation member 54 is expressed by the following Equation (4), where an attenuation coefficient of the second liquid material 542 is defined as α₂, a thickness (advancing distance of ultrasonic waves) of the second liquid material 542 is defined as d₂, an attenuation coefficient of the partition member 541 is defined as α_{S}, and a thickness (advancing distance of ultrasonic waves) of the partition member 541 is defined as dₛ.

αₜₒₜₐₗ=(α₂·d₂+α_{S}·d_{S})/(d₂+d_{S}) (4)

Therefore, even when one of the attenuation coefficients of the partition member 541 and the second liquid material 542 is larger than that of the first liquid material F, if a condition that the attenuation coefficient of the whole ultrasonic wave propagation member 54 is smaller than that of the first liquid material F is satisfied, an effect of the atomizing device according to the present embodiment to be described below can be obtained.

A conventional general atomizing device has a configuration to store a first liquid material to be atomized in an internal space of the housing and irradiate the first liquid material with ultrasonic waves by the ultrasonic transducer. Further, the atomizing device generates mist-like droplets by focusing the ultrasonic waves into a specific portion of the liquid level of the first liquid material to generate a liquid column of the first liquid material. Therefore, in order to obtain high atomization efficiency, it is important to propagate the ultrasonic waves generated by the ultrasonic transducer from a bottom surface of the housing to the liquid level without attenuating as much as possible.

Assuming that the frequency (of the ultrasonic wave is constant, the attenuation coefficient is proportional to viscosity (viscosity and bulk viscosity) of a material and inversely proportional to the power of the density and the sound velocity, according to Definition Equation (1) of the attenuation coefficient. The viscosity changes in an order of tens to thousands of times depending on a type and temperature of a material, whereas the density and sound velocity change only in an order of several times. Thus, the viscosity is dominant in the attenuation coefficient. That is, the higher the viscosity of the material, the larger the attenuation coefficient, and the ultrasonic waves are easily attenuated. Accordingly, in the conventional general atomizing device, in a case where the viscosity of the first liquid material is high, atomization efficiency is deteriorated because the attenuation of the ultrasonic wave is larger than that in a case where the viscosity of the first liquid material is low.

On the other hand, in the atomizing device 50 of the present embodiment, the ultrasonic waves generated by the ultrasonic wave generation unit 52 are propagated to the liquid level of the first liquid material F through the ultrasonic wave propagation member 54. Here, the viscosity of the second liquid material 542 consisting the ultrasonic wave propagation member 54 is lower than that of the first liquid material F, and the attenuation coefficient of the second liquid material 542 is smaller than that of the first liquid material F. In addition, the attenuation coefficient of the partition member 541 is smaller than that of the first liquid material F. That is, since the whole ultrasonic wave propagation member 54 has an attenuation coefficient smaller than that of the first liquid material F, the ultrasonic waves generated by the ultrasonic wave generation unit 52 are propagated to the liquid level of the first liquid material F in an attenuation smaller than before.

Since the second liquid material 542 and the partition member 541 are always present above the ultrasonic transducer 52 in the configuration of the present embodiment, the ultrasonic transducer 52 may not be operated without liquid. As described above, according to the atomizing device 50 of the present embodiment, high atomization efficiency can be ensured regardless of viscosity (type) of the first liquid material F to be atomized, without deteriorating reliability of the ultrasonic wave generation unit 52.

### Second Embodiment

Hereinafter, an atomizing device according to a second embodiment will be described with reference to FIG. 2.

The basic configuration of the atomizing device according to the second embodiment is the same as that of the first embodiment, and the configuration of the ultrasonic wave propagation member is different from that of the first embodiment.

FIG. 2 is a cross-sectional view of the atomizing device according to the second embodiment.

In FIG. 2, the same reference signs are given to components common to those used in the first embodiment in FIG. 1, and detailed description of those components will not be repeated.

As illustrated in FIG. 2, an ultrasonic wave propagation member 64 in an atomizing device 60 of the present embodiment also has a partition member 641 and a second liquid material 542, as in the first embodiment. The ultrasonic wave propagation member 64 is provided on a propagation path of the ultrasonic waves between an ultrasonic wave generation unit 52 and a first liquid material F in an internal space 51a of a housing 51. The ultrasonic wave propagation member 64 has acoustic transmittance higher than that of the first liquid material F.

The partition member 641 is made of a material having acoustic transmittance higher than that of the first liquid material F, such as rubber, polyethylene, or polystyrene. The partition member 641 of the present embodiment has a thickness larger than that of the partition member 541 of the first embodiment and larger than that of a layer of the second liquid material 542. The other configuration of the atomizing device 60 is the same as that of the atomizing device 50 of the first embodiment.

The atomizing device 60 of the present embodiment can obtain the same effect as the first embodiment in that high atomization efficiency can be ensured regardless of viscosity (type) of the liquid to be atomized, without deteriorating reliability of the ultrasonic wave generation unit 52.

Further, the atomizing device 60 of the present embodiment can obtain an effect capable of reducing a leakage of the second liquid material 542 in damage of the housing 51 because an amount of the second liquid material 542 is reduced by making the partition member 641 larger than in the first embodiment.

### Third Embodiment

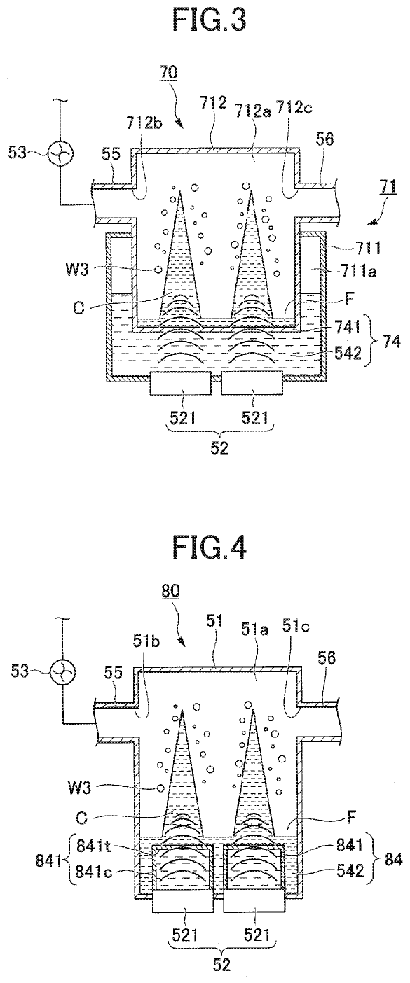

Hereinafter, an atomizing device according to a third embodiment will be described with reference to FIG. 3.

The basic configuration of the atomizing device according to the third embodiment is the same as that of the first embodiment, and the configuration of the ultrasonic wave propagation member is different from that of the first embodiment.

FIG. 3 is a cross-sectional view of the atomizing device according to the third embodiment.

In FIG. 3, the same reference signs are given to components common to those used in the first embodiment in FIG. 1, and detailed description of those components will not be repeated.

As illustrated in FIG. 3, an atomizing device 70 of the present embodiment includes a housing 71, an ultrasonic wave generation unit 52, an airflow generation unit 53, and an ultrasonic wave propagation member 74.

The housing 71 includes a first container 711 and a second container 712. The ultrasonic wave generation unit 52 is provided at a bottom plate of the first container 711. An air supply port 712b and an air discharge port 712c are provided in the second container 712. A constituent material of the first container 711 is not particularly limited, but the second container 712 is made of a material having higher acoustic transmittance higher than that of a first liquid material F, such as rubber, polyethylene, or polystyrene.

The first container 711 has a size capable of accommodating the second container 712 in an internal space 711a. The second container 712 is attachable to and detachable from the internal space 711a of the first container 711. In addition, a configuration is preferable in which the internal space 711a of the first container 711 is sealed so that a gap cannot be formed between the first container 711 and the second container 712 in a state where the second container 712 is mounted in the first container 711. For example, a sealant may be provided at the contact portion between the first container 711 and the second container 712.

The ultrasonic wave propagation member 74 has a partition member 741 and a second liquid material 542. The ultrasonic wave propagation member 74 has acoustic transmittance higher than that of the first liquid material F. In a case of the present embodiment, at least a part (bottom plate and a part of side plate) of the second container 712 functions as the partition member 741 in a state where the second container 712 is mounted in the first container 711. The first liquid material F is stored in an internal space 712a of the second container 712. The second liquid material 542 is stored in a space between the first container 711 and the second container 712.

The other configuration of the atomizing device 70 is the same as that of the first embodiment.

The atomizing device 70 of the present embodiment can obtain the same effect as the first embodiment in that high atomization efficiency can be ensured regardless of viscosity (type) of the liquid to be atomized, without deteriorating reliability of the ultrasonic wave generation unit 52.

Further, the atomizing device 70 of the present embodiment can obtain an effect capable of easily cleaning the containers 711 and 712 and performing maintenance work because a user can remove the second container 712 from the first container 711.

### Fourth Embodiment

Hereinafter, an atomizing device according to a fourth embodiment will be described with reference to FIG. 4.

The basic configuration of the atomizing device according to the fourth embodiment is the same as that of the first embodiment, and the configuration of the ultrasonic wave propagation member is different from that of the first embodiment.

FIG. 4 is a cross-sectional view of the atomizing device according to the fourth embodiment.

In FIG. 4, the same reference signs are given to components common to those used in the first embodiment in FIG. 1, and detailed description of those components will not be repeated.

As illustrated in FIG. 4, an ultrasonic wave propagation member 84 in an atomizing device 80 of the present embodiment has a partition member 841 and a second liquid material 542. The partition member 841 is provided on each ultrasonic transducer 521 to partition off an upper space of each of the plurality of ultrasonic transducers 521. The second liquid material 542 is stored in an internal space of each partition member 841. Each partition member 841 has side plates 841c and a top plate 841t, and is formed in a rectangular parallelepiped or cylindrical box shape. Each partition member 841 is made of a material having acoustic transmittance higher than that of the first liquid material F, such as polyethylene or polystyrene.

The other configuration of the atomizing device 80 is the same as that of the first embodiment.

The atomizing device 80 of the present embodiment can obtain the same effect as the first embodiment in that high atomization efficiency can be ensured regardless of viscosity (type) of the liquid to be atomized, without deteriorating reliability of the ultrasonic wave generation unit 52.

In the atomizing device 50 of the first embodiment, a design of the partition member 541 and a driving condition of the ultrasonic transducers 521 are determined on the assumption that all of the plurality of ultrasonic transducers 521 are operated normally. Therefore, if the partition member 541 is defective or deteriorated and ultrasonic waves cannot be transmitted, the liquid column C is less likely to be generated even if the ultrasonic transducer 521 is operating normally, such that the first liquid material F may be insufficiently atomized.

On the other hand, according to the atomizing device 80 of the present embodiment, even if one of a plurality of partition members 841 is defective or deteriorated, the other partition member 841 and the corresponding ultrasonic transducer 521 are operated normally, such that the first liquid material F is sufficiently atomized. In addition, for example, even if one of the plurality of partition members 841 is defective and the second liquid material 542 leaks to the first liquid material F, a leakage of the second liquid material 542 is smaller than in the first embodiment. As a result, a concentration of the first liquid material F does not change greatly, and thus the first liquid material F can be appropriately atomized.

### Fifth Embodiment

Hereinafter, an atomizing device according to a fifth embodiment will be described with reference to FIG. 5.

The basic configuration of the atomizing device according to the fifth embodiment is the same as that of the fourth embodiment, and the configuration of the partition member is different from that of the fourth embodiment.

FIG. 5 is a cross-sectional view of the atomizing device according to the fifth embodiment.

In FIG. 5, the same reference signs are given to components common to those used in the fourth embodiment in FIG. 4, and detailed description of those components will not be repeated.

As illustrated in FIG. 5, an ultrasonic wave propagation member 87 in an atomizing device 86 of the present embodiment has a partition member 871 and a second liquid material 542. As in the fourth embodiment, the partition member 871 is provided on each ultrasonic transducer 521 to partition off an upper space of each of the plurality of ultrasonic transducers 521. The second liquid material 542 is stored in the internal space of each partition member 871.

Each partition member 871 has side plates 871c and a top plate 871t, and is formed in a box shape. Each partition member 871 is made of a material having acoustic transmittance higher than that of the first liquid material F, such as polyethylene or polystyrene. The top plate 871t has a curved surface depressed downward. That is, the top plate 871t of the partition member 871 functions as an acoustic lens unit that converges the ultrasonic waves into a specific region of a liquid level of the first liquid material F. The top plate 871t forming the acoustic lens unit may have a curved surface protruding upward according to a relationship of magnitudes of sound velocity in the constituent materials of the respective portions.

The other configuration of the atomizing device 86 is the same as that of the first embodiment.

The atomizing device 86 of the present embodiment can obtain the same effect as the first embodiment in that high atomization efficiency can be ensured regardless of viscosity (type) of the liquid to be atomized, without deteriorating reliability of the ultrasonic wave generation unit 52.

Further, the atomizing device 86 of the present embodiment can obtain the same effect as the fourth embodiment in that the first liquid material F can be sufficiently atomized even if a part of the ultrasonic transducer 521 is broken, because the partition member 871 is provided on each ultrasonic transducer 521.

Further, since the partition member 871 of the atomizing device 86 of the present embodiment has the top plate 871t that functions as the acoustic lens unit, ultrasonic waves easily converge into a specific region of the liquid level of the first liquid material F. As a result, atomization efficiency can be further improved.

### Sixth Embodiment

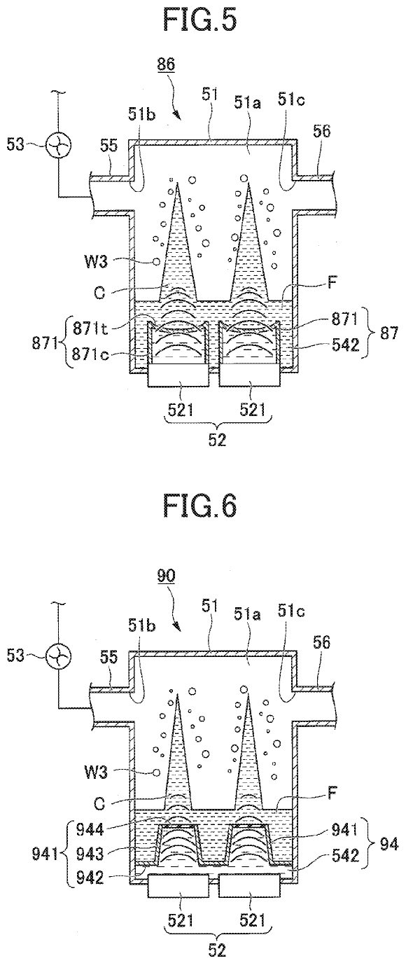

Hereinafter, an atomizing device according to a sixth embodiment will be described with reference to FIG. 6.

The basic configuration of the atomizing device according to the sixth embodiment is the same as that of the first embodiment, and the configuration of the partition member is different from that of the first embodiment.

FIG. 6 is a cross-sectional view of the atomizing device according to the sixth embodiment.

In FIG. 6, the same reference signs are given to components common to those used in the first embodiment in FIG. 1, and detailed description of those components will not be repeated.

As illustrated in FIG. 6, an ultrasonic wave propagation member 94 in an atomizing device 90 of the present embodiment has a partition member 941 and a second liquid material 542. The ultrasonic wave propagation member 94 has acoustic transmittance higher than that of a first liquid material F.

The partition member 941 includes a flat portion 942, a plurality of nozzles 943 (cylindrical portion) for converging ultrasonic waves toward a specific region of the first liquid material F, and a plurality of lid portions 944. The plurality of nozzles 943 are provided above each of a plurality of ultrasonic transducers 521 so as to protrude upward from the flat portion 942. Each of the nozzles 943 has a tapered and truncated cone shape in which upper and lower parts thereof are opened and an internal space is narrowed from a lower part to an upper part, that is, in a direction away from the ultrasonic transducer 521.

The plurality of nozzles 943 are formed integrally with the flat portion 942 of the partition member 941, and made of a material, for example, aluminum (acoustic impedance: 1.7×10⁷ kg/m²·s), brass (acoustic impedance: 4.0×10⁷ kg/m²·s), copper (acoustic impedance: 4.5×10⁷ kg/m²·s), iron (acoustic impedance: 4.7×10⁷ kg/m²·s), stainless steel (acoustic impedance: 4.6×10⁷ kg/m²·s), or the like. Since when the nozzle 943 is made of the above-described material, a difference between the acoustic impedance of the material and the acoustic impedance of the second liquid material 542 (for example, the acoustic impedance of water: 1.5×10⁶ kg/m²·s) is sufficiently large, the reflectance of ultrasonic waves on an inner surface of the nozzle 943 is increased, the loss of ultrasonic waves is reduced, and the atomization efficiency can be increased.

The lid portion 944 for closing an opening of each nozzle 943 is provided on each nozzle 943. The lid portion 944 is made of a material having acoustic transmittance higher than that of the first liquid material F, such as rubber, polyethylene, or polystyrene, used for the partition member 541 of the first embodiment.

The other configuration of the atomizing device 90 is the same as that of the first embodiment.

The atomizing device 90 of the present embodiment can obtain the same effect as the first embodiment in that high atomization efficiency can be ensured regardless of viscosity (type) of the liquid to be atomized, without deteriorating reliability of the ultrasonic wave generation unit 52.

Further, since the partition member 941 of the atomizing device 90 of the present embodiment includes the nozzle 943 arranged corresponding to each ultrasonic transducer 521, ultrasonic waves are repeatedly reflected inside the nozzle 943 and converge in the specific region of the liquid level. As a result, the atomization efficiency can be further improved.

### Seventh Embodiment

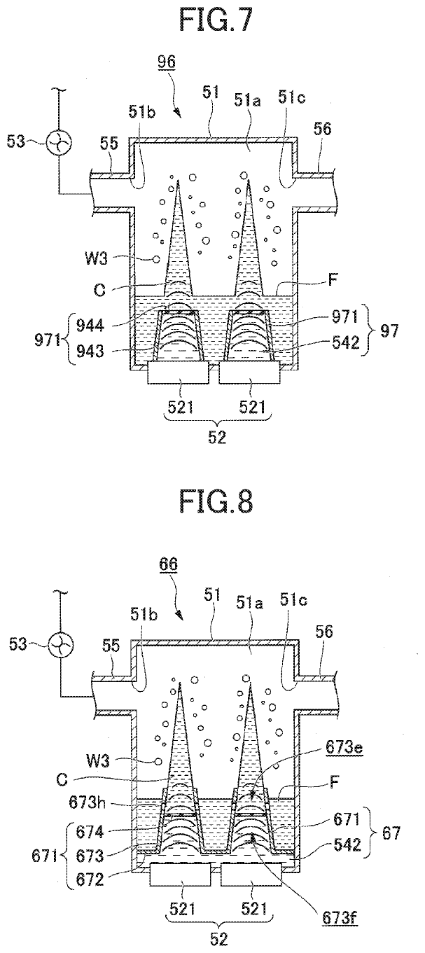

Hereinafter, an atomizing device according to a seventh embodiment will be described with reference to FIG. 7.

The basic configuration of the atomizing device according to the seventh embodiment is the same as that of the sixth embodiment, and the configuration of the nozzle is different from that of the sixth embodiment.

FIG. 7 is a cross-sectional view of the atomizing device according to the seventh embodiment.

In FIG. 7, the same reference signs are given to components common to those used in the sixth embodiment in FIG. 6, and detailed description of those components will not be repeated.

As illustrated in FIG. 7, an ultrasonic wave propagation member 97 in an atomizing device 96 of the present embodiment has a partition member 971 and a second liquid material 542. The ultrasonic wave propagation member 97 has acoustic transmittance higher than that of a first liquid material F.

The partition member 971 includes a plurality of nozzles 943 (cylindrical portions) for converging ultrasonic waves toward a specific region on the liquid level of the first liquid material F and a plurality of lid portions 944, without having the flat portion 942 in the sixth embodiment. The nozzle 943 is provided to contact an upper surface of each of the plurality of ultrasonic transducers 521. The lid portion 944 is provided on each nozzle 943. The second liquid material 542 is stored in an internal space of the nozzle 943.

The other configuration of the atomizing device 96 is the same as that of the sixth embodiment.

The atomizing device 96 of the present embodiment can obtain the same effect as the first embodiment in that high atomization efficiency can be ensured regardless of viscosity (type) of the liquid to be atomized, without deteriorating reliability of the ultrasonic wave generation unit 52.

Further, since an upper part of the ultrasonic transducer 521 is a space sealed by the nozzle 943 and the lid portion 944 in the atomizing device 96 of the present embodiment, ultrasonic vibration is more efficiently amplified than in the sixth embodiment, such that the atomization efficiency can be further improved.

### Eighth Embodiment

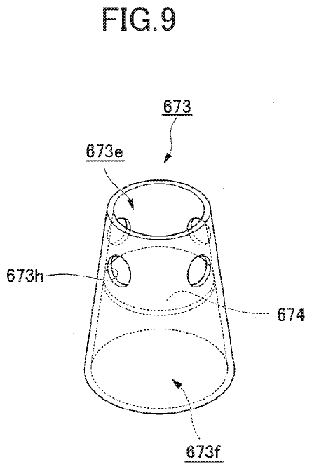

Hereinafter, an atomizing device according to an eighth embodiment will be described with reference to FIGS. 8 and 9.

The basic configuration of the atomizing device according to the eighth embodiment is the same as that of the sixth embodiment, and the configuration of the nozzle is different from that of the sixth embodiment.

FIG. 8 is a cross-sectional view of the atomizing device according to the eighth embodiment. FIG. 9 is a perspective view of a nozzle in the atomizing device according to the eighth embodiment.

In FIGS. 8 and 9, the same reference signs are given to components common to those used in the sixth embodiment in FIG. 6, and detailed description of those components will not be repeated.

As illustrated in FIG. 8, an ultrasonic wave propagation member 67 in an atomizing device 66 of the present embodiment has a partition member 671 and a second liquid material 542. The ultrasonic wave propagation member 67 has acoustic transmittance higher than that of a first liquid material F.

The partition member 671 includes a flat portion 672, a plurality of nozzles 673 (cylindrical portion), and a plurality of lid portions 674. The plurality of nozzles 673 are provided above each of the plurality of ultrasonic transducers 521 to project upward from the flat portion 672.

As illustrated in FIG. 9, the nozzle 673 has a tapered and truncated cone shape in which upper and lower parts thereof are opened, as in the sixth embodiment. However, unlike the sixth embodiment, the nozzle 673 has a plurality of inflow ports 673h allowing the first liquid material F to flow into the nozzle 673. The number and positions of the plurality of inflow ports 673h are not particularly limited.

Unlike the sixth embodiment, the lid portion 674 is provided inside the nozzle 673. As a result, the inside of the nozzle 673 is divided into a first space 673e in which the first liquid material F is stored and a second space 673f in which the second liquid material 542 is stored by the lid portion 674. In addition, the plurality of inflow ports 673h are provided above the lid portion 674. Thus, an external space of the nozzle 673 and the first space 673e communicate with each other through the inflow port 673h.

The other configuration of the atomizing device 66 is the same as that of the sixth embodiment.

The atomizing device 66 of the present embodiment can obtain the same effect as the first embodiment in that high atomization efficiency can be ensured regardless of viscosity (type) of the liquid to be atomized, without deteriorating reliability of the ultrasonic wave generation unit 52.

Since the nozzle 673 is provided with the plurality of inflow ports 673h in the atomizing device 66 of the present embodiment, the first liquid material F is stored in the first space 673e of the nozzle 673. In other words, the upper part (tip end side) of the nozzle 673 extends above the liquid level of the first liquid material F. Thus, the ultrasonic waves are guided to the liquid level of the first liquid material F by the nozzle 673 and efficiently converged into a specific region of the liquid level of the first liquid material F. As a result, the atomization efficiency can be further improved.

### Ninth Embodiment

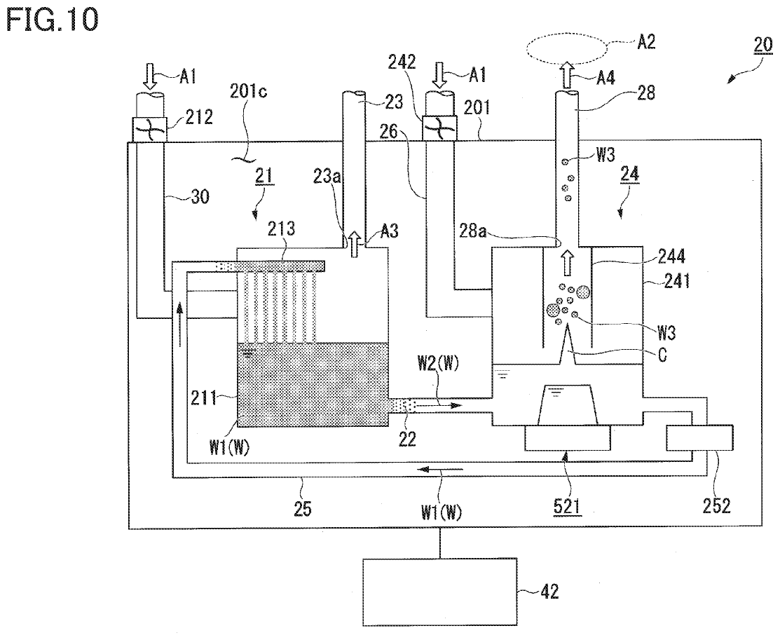

Hereinafter, a ninth embodiment of the present invention will be described with reference to FIG. 10.

In the present embodiment, a humidity regulating device including the atomizing device exemplified in the first to eighth embodiments will be described.

FIG. 10 is a schematic configuration diagram of a humidity regulating device according to the ninth embodiment.

As illustrated in FIG. 10, a humidity regulating device 20 of the present embodiment includes a moisture absorption unit 21, an atomization regeneration unit 24, a first liquid-moisture absorbing material transport flow path 22, and a second liquid-moisture absorbing material transport flow path 25, a first air introduction flow path 30, a second air introduction flow path 26, and a control unit 42. The humidity regulating device 20 further includes an outer shell housing 201, and the moisture absorption unit 21 and the atomization regeneration unit 24 are housed in an internal space 201c of the outer shell housing 201.

The moisture absorption unit 21 includes a first storage tank 211, a blower 212, and a moisture absorption unit nozzle 213. The moisture absorption unit 21 causes a liquid-moisture absorbing material W to absorb at least a part of moisture contained in air A1 by bringing the air A1 existing in an external space into contact with the liquid-moisture absorbing material W containing a hygroscopic substance. It is preferable that the moisture absorption unit 21 causes the liquid-moisture absorbing material W to absorb as much moisture as possible, but the moisture absorption unit 21 may cause the liquid-moisture absorbing material W to absorb at least part of the moisture contained in the air A1. The liquid-moisture absorbing material W is stored inside the first storage tank 211. The liquid-moisture absorbing material W will be described below. The first storage tank 211 is connected to the first air introduction flow path 30, a first air discharge flow path 23, and the first liquid-moisture absorbing material transport flow path 22. The air A1 is supplied to the internal space of the first storage tank 211 through the first air introduction flow path 30 by the blower 212.

The moisture absorption unit nozzle 213 is arranged above the internal space of the first storage tank 211. A liquid-moisture absorbing material W1, which has been regenerated by the atomization regeneration unit 24 to be described below and then returned to the moisture absorption unit 21 through the second liquid-moisture absorbing material transport flow path 25, flows down to the internal space of the first storage tank 211 from the moisture absorption unit nozzle 213, and at this time, the liquid-moisture absorbing material W1 brings into contact with the air A1. This type of contact form between the liquid-moisture absorbing material W1 and the air A1 is referred to as a “flow-down method”, in general. The contact form between the liquid-moisture absorbing material W1 and the air A1 is not limited to the flow-down method, and other methods thereof can be used. For example, it is also possible to use a method of supplying the air A1 in a form of bubbles in the liquid-moisture absorbing material W stored in the first storage tank 211, which is so-called a bubbling method.

In the air A1 existing in the external space, an airflow is formed from the blower 202 toward the air discharge port 23a of the first air discharge flow path 23 and brings into contact with the liquid-moisture absorbing material W flowing down from the moisture absorption unit nozzle 213. At this time, at least a part of moisture contained in the air A1 is removed by being absorbed into the liquid-moisture absorbing material W. In the moisture absorption unit 21, since air from which the moisture has been removed is obtained from original air in the indoor space, this air is drier than air in the external space of the humidity regulating device 20. As a result, the dried air is discharged inside through the first air discharge flow path 23.

The liquid-moisture absorbing material W is a liquid exhibiting a property of absorbing water (hygroscopicity), and for example, a liquid exhibiting hygroscopicity under conditions of a temperature of 25° C., a relative humidity of 50%, and an atmospheric pressure is preferable. The liquid-moisture absorbing material W contains a hygroscopic substance to be described below. In addition, the liquid-moisture absorbing material W may contain a hygroscopic substance and a solvent. Examples of this type of solvent include a solvent that dissolves a hygroscopic substance or is mixed with a hygroscopic substance, such as water. The hygroscopic substance may be an organic material or an inorganic material.

Examples of the organic materials used as the hygroscopic substance include polyhydric alcohol, ketone, an organic solvent containing an amino group, a saccharide, a known material used as a raw material for moisturizing cosmetics, and the like. Among them, examples of the organic materials preferably used as the hygroscopic substance because of high hydrophilicity include polyhydric alcohol, an organic solvent containing an amino group, a saccharide, a known material used as a raw material for moisturizing cosmetics, and the like.

Examples of the polyhydric alcohols include glycerin, propanediol, butanediol, pentanediol, trimethylolpropane, butanetriol, ethylene glycol, diethylene glycol, and triethylene glycol.

Examples of the organic solvent having an amide group include formamide and acetamide.

Examples of the saccharide include sucrose, pullulan, glucose, xylol, fructose, mannitol, and sorbitol.

Examples of the known materials used as raw materials for moisturizing cosmetics include 2-methacryloyloxyethyl phosphorylcholine (MPC), betaine, hyaluronic acid, collagen, and the like.

Examples of the inorganic material used as the hygroscopic substance include calcium chloride, lithium chloride, magnesium chloride, potassium chloride, sodium chloride, zinc chloride, aluminum chloride, lithium bromide, calcium bromide, potassium bromide, sodium hydroxide, pyrrolidone carboxylate, and the like.

If the hygroscopic substance has high hydrophilicity, for example, when a material of hygroscopic substance is mixed with water, a proportion of water molecules in the vicinity of the surface (liquid level) of the liquid-moisture absorbing material W increases. In the atomization regeneration unit 24 which will be described below, mist-like droplets are generated from the vicinity of the surface of the liquid-moisture absorbing material W to separate the moisture from the liquid-moisture absorbing material W. Therefore, it is preferable in that if the proportion of water molecules in the vicinity of the surface of the liquid-moisture absorbing material W is large, the moisture can be efficiently separated. Further, since the proportion of the hygroscopic substance in the vicinity of the surface of the liquid-moisture absorbing material W is relatively small, it is preferable in that a loss of the hygroscopic substance in the atomization regeneration unit 24 is suppressed.

In the liquid-moisture absorbing material W, a concentration of the hygroscopic substance contained in the liquid-moisture absorbing material W1 used for treatment in the moisture absorption unit 21 is not particularly limited, and is preferably 40% by mass or more. When the concentration of the hygroscopic substance is 40% by mass or more, the liquid-moisture absorbing material W1 can efficiently absorb the moisture.

It is preferable that the liquid-moisture absorbing material W has a viscosity of 25 mPa·s or less. As a result, the liquid column C of the liquid-moisture absorbing material W is likely to be generated on the liquid level of the liquid-moisture absorbing material W in the atomization regeneration unit 24 to be described below. Therefore, the moisture can be efficiently separated from the liquid-moisture absorbing material W. However, the present embodiment includes the atomizing devices of the first to eighth embodiments that can obtain high atomization efficiency regardless of the viscosity of the liquid to be atomized, as the atomization regeneration unit 24. Therefore, even if liquid-moisture absorbing material W has a high viscosity, the moisture can be separated more efficiently than in the conventional case.

The atomization regeneration unit 24 includes a second storage tank 241, a blower 242, an ultrasonic transducer 521, and a guide pipe 244. The atomization regeneration unit 24 atomizes at least a part of moisture contained in a liquid-moisture absorbing material W2 supplied from the moisture absorption unit 21 through the first liquid-moisture absorbing material transport flow path 22 and removes at least a part of moisture from the liquid-moisture absorbing material W2, thereby regenerating the liquid-moisture absorbing material W2. The liquid-moisture absorbing material W2 to be regenerated is stored in the second storage tank 241. The first liquid-moisture absorbing material transport flow path 22, the second liquid-moisture absorbing material transport flow path 25, the second air introduction flow path 26, and the second air discharge flow path 28 are connected to the second storage tank 241. The second storage tank 241 corresponds to the housing in the atomizing devices of the first to eighth embodiments.

The blower 242 sends air A1 from an external space of the outer shell housing 201 to the inside of the second storage tank 241 through the second air introduction flow path 26 to generate an airflow flowing from the inside of the second storage tank 241 to the outside of the outer shell housing 201 through the second air discharge flow path 28.

The ultrasonic transducer 521 irradiates the liquid-moisture absorbing material W2 with ultrasonic waves to generate mist-like droplets W3 containing moisture from the liquid-moisture absorbing material W2. The ultrasonic transducer 521 is provided in contact with a bottom plate of the second storage tank 241. When the liquid-moisture absorbing material W2 is irradiated with the ultrasonic waves from the ultrasonic transducer 521, the liquid column C of the liquid-moisture absorbing material W2 can be generated on the liquid level of the liquid-moisture absorbing material W2 by adjusting a generation condition of the ultrasonic waves. Most of the mist-like droplets W3 are generated from the liquid column C of the liquid-moisture absorbing material W2 and the vicinity thereof.

The guide pipe 244 guides the mist-like droplets W3 generated from the liquid-moisture absorbing material W2 to an air discharge port 28a of the second air discharge flow path 28. When the humidity regulating device 20 is viewed from above, the guide pipe 244 is provided to surround the air discharge port 28a.

The second air discharge flow path 28 discharges air A4 containing the mist-like droplets W3 to the external space of the outer shell housing 201 and removes the air A4 from the inside of the humidity regulating device 20. Thereby, the moisture can be separated from the liquid-moisture absorbing material W2. As a result, a hygroscopic performance of the liquid-moisture absorbing material W2 is enhanced again, and the liquid-moisture absorbing material W2 can thus be returned to the moisture absorption unit 21 and reused. The air A4 contains the mist-like droplets W3 generated inside the second storage tank 241, and is thus more moist than the air A2 in the external space of the outer shell housing 201. Thus, the humidified air A4 is discharged into an indoor space through the second air discharge flow path 28.

When the atomization regeneration unit 24 is viewed from above, the air discharge port 28a planarly overlaps the ultrasonic transducer 521, so that the liquid column C of the liquid-moisture absorbing material W2 is generated below the air discharge port 28a. Therefore, in the atomization regeneration unit 24, the guide pipe 244 is designed to surround the liquid column C generated in the liquid-moisture absorbing material W2. Owing to such a positional relationship with the air discharge port 28a, the guide pipe 244, and the liquid column C, the mist-like droplets W3 generated from the liquid column C of the liquid-moisture absorbing material W2 is guided to the air discharge port 28a due to the airflow directed upward from the liquid level of the liquid-moisture absorbing material W2.

The moisture absorption unit 21 and the atomization regeneration unit 24 are connected to each other by the first liquid-moisture absorbing material transport flow path 22 and the second liquid-moisture absorbing material transport flow path 25 that form a circulation flow path of the liquid-moisture absorbing material W. A pump 252 for circulating the liquid-moisture absorbing material W is provided in the middle of the second liquid-moisture absorbing material transport flow path 25.

The first liquid-moisture absorbing material transport flow path 22 transports the liquid-moisture absorbing material W, in which at least a part of moisture is absorbed, from the moisture absorption unit 21 to the atomization regeneration unit 24. One end of the first liquid-moisture absorbing material transport flow path 22 is connected to a lower part of the first storage tank 211. A connection portion of the first liquid-moisture absorbing material transport flow path 22 in the first storage tank 211 is located below the liquid level of the liquid-moisture absorbing material W1 in the first storage tank 211. On the other hand, the other end of the first liquid-moisture absorbing material transport flow path 22 is connected to a lower part of the second storage tank 241. A connection portion of the first liquid-moisture absorbing material transport flow path 22 in the second storage tank 241 is located below the liquid level of the liquid-moisture absorbing material W2 in the second storage tank 241.

The second liquid-moisture absorbing material transport flow path 25 transports the regenerated liquid-moisture absorbing material W, from which the moisture is removed, from the moisture absorption unit 21 to the atomization regeneration unit 24. One end of the second liquid-moisture absorbing material transport flow path 25 is connected to a lower part of the second storage tank 241. The connection portion of the second liquid-moisture absorbing material transport flow path 25 in the second storage tank 241 is located below the liquid level of the liquid-moisture absorbing material W2 in the second storage tank 241. On the other hand, the other end of the second liquid-moisture absorbing material transport flow path 25 is connected to an upper part of the first storage tank 211. The connection portion of the second liquid-moisture absorbing material transport flow path 25 in the first storage tank 211 is located above the liquid level of the liquid-moisture absorbing material W1 in the first storage tank 211, and is connected to the above-described moisture absorption unit nozzle 213.

Described above is that in the humidity regulating device 20, the dehumidified air is discharged from the moisture absorption unit 21 through the first air discharge flow path 23, and the humidified air is discharged from the atomization regeneration unit 24 through the second air discharge flow path 28. For a humidity regulating function, when the humidity regulating device 20 of the present embodiment is an air conditioning device having only a dehumidifying function, for example, the air discharge port of the first air discharge flow path 23 is arranged toward an indoor space, whereas the air discharge port of the second air discharge flow path 28 may be arranged toward an outdoor space. Alternatively, when the humidity regulating device 20 of the present embodiment is an air conditioning device having only a humidifying function, for example, the air discharge port of the second air discharge flow path 28 is arranged toward the indoor space, whereas the air discharge port of the first air discharge flow path 23 may be arranged toward the outdoor space. Further, when the humidity regulating device 20 of the present embodiment is an air conditioning device having both the dehumidifying function and the humidifying function, the air discharge ports of both the first air discharge flow path 23 and the second air discharge flow path 28 is arranged toward the indoor space, and the control unit 42 may control whether the air from any of the air discharge ports is discharged.

The technical scope of the present invention is not limited to the above embodiments and various modifications can be added in the range without departing from the spirit of the present invention.

For example, in the atomizing device according to the above-described embodiment, no portion for flowing in and flowing out the first liquid material or the second liquid material in the housing is provided, but this type of the portion may be provided.

The atomizing device may include a mechanism or a control system for keeping a liquid level of the first liquid material low. Furthermore, the atomizing device may include means for detecting the absence of the first liquid material above the ultrasonic transducer to temporarily stop the device or to inform a user of the absence in a case where there is no first liquid material above the ultrasonic transducer due to inclination of the housing or the like, while keeping the liquid level of the first liquid material low. Similarly, the atomizing device may include means for detecting the absence of the second liquid material above the ultrasonic transducer to temporarily stop the device or to inform a user of the absence in a case where there is no second liquid material above the ultrasonic transducer.

Further, a structure for suppressing the reflection of the ultrasonic waves, for example, a ¼ wavelength film, a fine uneven structure, or the like may be imparted to an interface between the partition member and the second liquid material or an interface between two types of substances having different acoustic transmittances. As a result, a reflection loss of ultrasonic waves is suppressed, and atomization efficiency can be improved.

In the above-described embodiment, the configuration in which the ultrasonic wave propagation member is constituted by the partition member and the second liquid material is illustrated, but the whole ultrasonic wave propagation member may be made of, for example, a solid such as a gel. Generally, an absorption rate of the ultrasonic wave increases in the order of a solid, a low-viscosity liquid, and a high-viscosity liquid. Therefore, the ultrasonic waves having a higher strength is propagated to the liquid level of the first liquid material by using a solid material as the ultrasonic wave propagation member, and as a result, atomization efficiency can be enhanced as compared with a case of using the high-viscosity liquid as the ultrasonic wave propagation member.

### INDUSTRIAL APPLICABILITY

The atomizing device according to the present invention can be used in various devices such as a nebulizer, a separation device, a coating device, and a liquid concentration device, in addition to the above-mentioned humidity regulating device.

1. An atomizing device comprising:
a housing that has an internal space for storing a first liquid material to be mist-like droplets and an air discharge port;
an ultrasonic wave generation unit that is provided in the housing and generates the mist-like droplets by irradiating the first liquid material with ultrasonic waves;
an airflow generation unit that generates an airflow for sending at least a part of the mist-like droplets from the internal space to the outside through the air discharge port; and
an ultrasonic wave propagation member that is provided on a propagation path of the ultrasonic waves between the ultrasonic wave generation unit and the first liquid material in the internal space, and has an attenuation coefficient smaller than an attenuation coefficient of the first liquid material.

2. The atomizing device according to claim 1,
wherein the ultrasonic wave propagation member has a partition member that partitions the internal space, and
at least a part of the partition member is made of a material having an attenuation coefficient smaller than the attenuation coefficient of the first liquid material.

3. The atomizing device according to claim 2,
wherein the ultrasonic wave propagation member contains a second liquid material having a viscosity lower than a viscosity of the first liquid material,
the second liquid material is stored in a space close to the ultrasonic wave generation unit among a plurality of spaces partitioned off by the partition member, and
the first liquid material is stored in a space far from the ultrasonic wave generation unit among the plurality of spaces.

4. The atomizing device according to claim 3,
wherein the housing includes a first container and a second container that is attachable to and detachable from an internal space of the first container,
at least a part of the second container functions as the partition member in a state where the second container is mounted in the internal space of the first container,
the second liquid material is stored in a space between the first container and the second container, and
the first liquid material is stored in an internal space of the second container.

5. The atomizing device according to claim 3,
wherein the ultrasonic wave generation unit includes a plurality of ultrasonic transducers, and
the partition member is provided to partition off an upper space of each of the plurality of ultrasonic transducers.

6. The atomizing device according to claim 3,
wherein the partition member has a thickness larger than a thickness of a layer of the second liquid material.

7. The atomizing device according to claim 2,
wherein the partition member includes an acoustic lens unit that converges the ultrasonic waves toward a specific region of the first liquid material.

8. The atomizing device according to claim 2,
wherein the partition member includes a cylindrical portion that converges the ultrasonic waves toward a specific region of the first liquid material.

9. The atomizing device according to claim 8,
wherein the cylindrical portion has an inflow port that allows the first liquid material to flow into the cylindrical portion.

10. A humidity regulating device comprising:
a moisture absorption unit that causes a liquid-moisture absorbing material to absorb at least a part of moisture contained in air by bringing the liquid-moisture absorbing material containing a hygroscopic substance into contact with the air; and
an atomization regeneration unit that regenerates the liquid-moisture absorbing material by atomizing and removing at least a part of moisture contained in the liquid-moisture absorbing material supplied from the moisture absorption unit,
wherein the atomization regeneration unit includes the atomizing device according to claim 1.
